(19) United States
(12) Patent Application Publication
(10) Pub. No.: US 2012/0278191 A1
(43) Pub. Date: Nov. 1, 2012

(54) METHODS AND SYSTEMS FOR SELLING AND BUYING TICKETS

(76) Inventors: Andrew J. Aschettino, Trumbull, CT (US); Charles J. Piccoli, III, Valhalla, NY (US)

(21) Appl. No.: 13/095,442

(22) Filed: Apr. 27, 2011

(51) Int. Cl. G06Q 30/00

(52) U.S. Cl. 705/26.1

(57) ABSTRACT

Methods and systems for the sale of tickets to a particular event by a ticket source to buyers who can purchase a ticket to the event based upon the participation of a particular individual or team by making periodic payments towards such purchase for so long as the particular individual or team can still qualify to participate in the event. If the particular individual or team is eliminated from the possibility of participating in the event, the buyer's obligation to make any subsequent periodic payments to the ticket source lapses and the ticket source's obligation to deliver a ticket to the buyer for the event lapses. If the particular individual or team qualifies, and the buyer has made all the requisite payments to the ticket source, the buyer ends up “scoring” a ticket to the event from the ticket source. Others can bid to acquire a buyer's right to purchase a ticket from the ticket source. Methods and systems including a database having stored therein information pertaining to ticket rights available for acquisition, the price at which available ticket rights may be acquired, and the remaining number and amount of payments that have to be made to the ticket source in order to complete the purchase.

### BACKGROUND OF THE INVENTION

The Internet, a global system of interconnected computer networks formed into a single worldwide network, offers geographically distributed buyers and sellers unprecedented opportunities to interact with each other and to engage in electronic commerce.

The global penetration of the Internet provides sellers with the capability to sell their wares to substantial audiences of buyers using an online merchant system. Online merchant systems enable sellers to creatively display and describe their wares to potential buyers using Web pages. Web sellers can display Web pages having content, such as text, pictures, sound and video, using HyperText Markup Language (HTML). Web buyers, in turn, can access the Web pages of sellers using a browser, such as Microsoft's INTERNET EXPLORER or Google's CHROME, installed on a computer or other device connected to the Web through an online service provider. The browser interprets the HTML to format and display the seller's page for the buyer. The online merchant system enables buyers to browse through a seller's store to identify wares of interest, to obtain specific information regarding the wares and to electronically purchase wares after reviewing product information.

Novel methods of purchasing and selling wares via the Internet have been developed, including cryptographic systems and methods for assuring authenticity of a signer of a transaction, electronic payment systems, and electronic auction systems and methods. Electronic commerce Internet sites typically allow remotely distributed users to interact via an Internet site, through which the users execute traditional commercial transactions online.

While the Internet typically offers convenience, it has not significantly altered the underlying transaction contexts. The present online methods of selling wares also do not generally account for the possible presence of uncertainty in connection with those wares. More specifically, it is well recognized that a buyer who purchases something in advance may be disappointed if the purchased item changes by the time that the actual purchase is consummated, as often happens when the desire to purchase something is primarily motivated by the outcome of one or more events.

In addition, the present online methods of selling wares do not enable buyers to make initial requisite partial payments toward a desired purchase, and then to discontinue making subsequent requisite partial payments for any one of a variety of reasons, for example: (i) because changed circumstances suggest to the buyer that the desired item will not, in fact, ultimately be available for purchase; (ii) because the buyer does not want to make the subsequent payments necessary to purchase the item; or (iii) because the buyer wants to assign to a third party the benefit of the initial payments that the buyer has already made and the right to continue to make subsequent payments and thereby complete the purchase.

An example of a market involving uncertainty is the market for tickets in connection with a sporting event, especially a sporting event in which the presence of a particular individual or team is not known well in advance of the time of the event. One such event is the SUPER BOWL. NFL fans are notoriously loyal to particular teams, but the two particular teams that will appear in the SUPER BOWL are not known until two weeks before the game. A fan of a particular team is unlikely to wish to purchase a SUPER BOWL ticket unless his team will be in the game. In other words, the fan's desire to attend the SUPER BOWL is contingent upon the outcome of prior events, namely the progression of their team through the earlier season and playoff games.

If, however, a fan's team indeed does qualify to participate in the “big game,” e.g., the SUPER BOWL, the fanatical fan will do just about anything to “score” a ticket to the event. Unfortunately, at that point in time, the fan's chances (absent a fat wallet) are—for all intents and purposes—virtually nil.

### SUMMARY OF THE INVENTION

Disclosed herein are methods and systems for selling and buying tickets for attendance at events. More particularly, in accordance with the present invention, computer networks which allow an increasingly large number of sellers and buyers to participate in electronic markets may be used to facilitate transactions wherein tickets are offered for sale and sold based on the occurrence of such contingencies as the participation of a given individual or team in a sports event.

As used herein, “computer network” should be understood to include the Internet, worldwide web, wide area networks, local area networks, Intranets, Extranets, telephone networks, cellular networks, and other connections capable of supporting communications, file transfers, and other functions over distance.

Tickets to a particular sports event are offered for sale by a ticket source. A buyer commits to purchase a ticket to the sports event from the ticket source so long as a particular individual or team participates in the sports event. Once that commitment is made, the buyer makes initial payments to the ticket source towards that purchase. For so long as the desired outcome, i.e., the participation of the particular individual or team in the sports event, is still possible, the buyer continues to make payments to the ticket source. If there comes a time when the desired outcome is no longer possible, i.e., the particular individual or team has been eliminated from the possibility of participating in the sports event, the buyer's ability to purchase the ticket is lost and the obligation to make any subsequent payments to the ticket source that would otherwise be due lapses and the ticket source's obligation to deliver the buyer a ticket to the sports event lapses.

If the particular individual or team is not eliminated, but rather, qualifies to participate in the sports event, and if the buyer continues to make all requisite payments to the ticket source, the buyer ends up “scoring” a ticket to the sports event from the ticket source.

Also disclosed herein are methods and systems for allowing a third party to bid to acquire the rights to purchase a ticket to an event from a buyer that made the original commitment to purchase the ticket from the ticket source and has thereafter timely made all requisite payments. Such methods and systems include a database having stored therein information pertaining to ticket rights available for acquisition, the price at which available ticket rights may be acquired, and the remaining number and amount of payments the third party would have to make to the ticket source in order to complete the purchase of the ticket after the ticket rights have been acquired from the original buyer.

If, at any time prior to when the particular individual or team is eliminated, including at a time when the particular individual's or team's participation in the event is assured, the original buyer desires, for whatever reason, to stop making payments towards the purchase of the particular ticket, the original buyer is given the opportunity to offer a third party the right to take the original buyer's place. In essence, the third party can pay the original buyer an amount negotiated between them, based upon the prior payments already made and the potential for the particular individual or team to qualify to participate in the event.

The systems and methods disclosed herein may establish a marketplace in which a person seeking an event ticket may initially commit to make the requisite payments for such ticket, and such person may indeed make the initial payments, such as on a host Internet site, only to subsequently conclude not to make all the requisite payments, and to transfer the benefit of the payments already made and the right to make future payments to a third party.

If the buyer who has committed to purchase a ticket from the ticket source fails, for whatever reason, to make the requisite payments as they come due in connection with a ticket purchase commitment, without having assigned the ticket purchase rights to a third party that assumes the further payment obligations, the buyer is deemed to have forfeited the right to purchase a ticket and the right can be resold by the ticket source in the secondary market.

In practice, if a particular team loses a game, then the probability of that team's participation in the event is reduced, thus reducing the value of the right to purchase a ticket to the ultimate event involving that team. As the value diminishes, the buyer may be willing to assign the right to purchase the ticket to a third party to recover all or some of the purchase price already paid. Similarly, a third party may be willing to buy, but only at a lower price. Thus, a marketplace can be established where purchasers and sellers trade in the right to make subsequent payments and complete the purchase of the ticket from the ticket source.

Conversely, if a particular team wins a game, then the probability of that team's participation in the event is increased, thus increasing the value of the right to purchase a ticket to the ultimate event involving that team. At the time of making the initial commitment to purchase a ticket contingent upon the team's participation, the buyer would likely have had a certain amount of unease that causes him to only be willing to make initial, lower, payments. As the value increases with one or more wins, however, the buyer would likely be willing to pay an increased amount to the ticket source in connection with subsequent payments. Thus, a marketplace can be established where the ticket source is able to structure a graduated payment schedule that enables the cost of an initial commitment to be held down while the cost of subsequent payments can increase. If the increase becomes prohibitive for the buyer or if for whatever reason the buyer wants to assign the right to make subsequent payments and complete the purchase of the ticket from the ticket source, the buyer is likely to be able to do so at a price greater than what the buyer has paid.

In the systems and methods disclosed by the present invention, it is not possible for ticket rights to be sold except by individuals who have actually acquired the right to purchase a ticket from the ticket source, i.e., mechanisms are specifically put in place to insure that fraudulent “sale” of phantom ticket rights does not occur.

In the systems and methods disclosed by the present invention, recognition is given to the fact that the perceived likelihood of a particular individual or team participating in a sports event varies depending upon the individual or team in question. In essence, the “odds” of one individual or team “A” qualifying for participation in the sports event are different, i.e., greater, than the “odds” of another individual or team “B” participating. Accordingly, all things being “equal,” prospective buyers are less willing to commit to the purchase of a ticket when the right to purchase the ultimate ticket is contingent upon the participation of team B.

In the systems and methods disclosed by the present invention, recognition is given to the fact that the level of interest in a particular individual or team participating in a sports event varies depending upon the individual or team in question. In essence, the fans of one individual or team “C” may be more “faithful” than the fans of another individual or team “D.” By way of example, the Boston Red Sox always sell out their games whereas other teams have difficulty drawing a crowd. Accordingly, all things being “equal,” prospective buyers are less willing to commit to the purchase of a ticket when the right to purchase the ultimate ticket is contingent upon the participation of team D.

The systems and methods of the present invention address these demand disparities through tiered pricing, i.e., the amount that the buyer must commit to pay to purchase a ticket to the sports event if individual or team “A” or “C” participates is greater than what the buyer must commit to pay to purchase a ticket if individual or team “B” or “D” participates.

An individual wants to go to a sports event if their team is a participant. The individual goes to a website operated using the methods and systems of the disclosed invention and enters into an agreement with the website, whereby the individual makes a commitment to purchase a ticket if their team makes it to the sports event and the website in turn commits to deliver a ticket to the individual if their team is a participant. The individual begins paying the site a weekly fee, e.g., X, on a preset day of each week during the season. The amount at which the weekly payment for a particular team is set will vary depending upon the likelihood (odds) of the team's qualifying to participate in the event. As the weeks pass, and the individual's team plays qualifying games, the individual can choose to opt out at any time if the individual is not satisfied with their team's success. As the individual's team reaches certain win thresholds, the weekly fee which the individual must pay to the site begins to rise, e.g., to Y, Z—the amount and number of price rises that can occur can vary and is set at the time of the agreement. In the end, the individual: (i) either opts out early, (ii) their team is eliminated and the agreement lapses, or (iii) the individual makes all the required payments, their team qualifies to participate in the event and the website delivers a ticket to the event to the individual.

An object of the methods and systems of the disclosed invention is that an individual can make an initial commitment for a reasonable amount of money and minimize their risk.

A further object is to provide an individual with the opportunity to enter into an agreement to purchase a ticket to an event with the price taking into account the likelihood (odds) of the individual's team qualifying for the participation in the event.

A further object is that an individual can, for financial or any other reason, opt out and sell their right to acquire a ticket in a secondary market.

A still further object is that an individual can get a ticket to an event at a fair price.

A still further object is that the individual receives the ticket after making the scheduled payments without having to pay an additional amount equal to the face amount of the ticket or some other amount.

### BRIEF DESCRIPTION OF THE FIGURES

FIG. 1 depicts a schematic of ticket rights acquisition involved in an embodiment of the methods and systems disclosed herein.

FIG. 2 depicts a schematic of ticket rights distribution involved in an embodiment of the methods and systems disclosed herein.

FIG. 3 depicts a schematic of a secondary ticket rights market involved in an embodiment of the methods and systems disclosed herein.

FIG. 4 depicts the ticket rights-buyers interface involved in an embodiment of the methods and systems disclosed herein.

FIG. 5 is a schematic depiction of varying buyer payment experiences in an embodiment of the methods and systems disclosed herein.

FIG. 6 is a schematic depiction of possible pricing tiers grouping teams based upon the likelihood of their qualifying to participate in a sporting event in an embodiment of the methods and systems disclosed herein.

FIG. 7 is a chart illustrating weekly tiered payment amounts based upon wins of tiered teams in accordance with an embodiment of the invention.

FIGS. 8A-8E are charts illustrating payments that will be made by the buyers identified in FIG. 2 in accordance with an embodiment of the invention.

FIGS. 9A-9E are charts illustrating tiered payment amounts for seating zones in accordance with an embodiment of the invention.

FIG. 10 is a flow chart illustrating steps involved in effecting a secondary market transaction for the sale of a ticket right in accordance with an embodiment of the invention.

### DETAILED DESCRIPTION OF THE INVENTION

Disclosed herein is a system for allowing a remote user (or “original” buyer) to purchase, over a distributed computer network (e.g., the Internet), a ticket to an event that is based on a contingency, e.g., a ticket to an event which is certain to occur but for which the participants are not predetermined. For instance, the subject system can be used to sell tickets for such contingent sports events as playoff games on the basis of what teams qualify, or who may appear in an all-star game.

In general, the system comprises a host server operative with a program including: (i) a primary ticket source (“T.S.”) database connected in communication with said host server, said primary database including information pertaining to: (a) original ticket rights available for contingent sporting events to be made available upon the occurrence of a contingency, (b) original buyers who have committed to purchase the original ticket rights, and (c) pricing and required payments from the original buyers for the original ticket rights; (ii) a secondary market (“S.M.”) database connected in communication with said host server and said primary ticket source database, said secondary market database including information pertaining to: (a) unsold ticket rights available for contingent sporting events, (b) ticket rights offered for resale by original buyers of original ticket rights, (c) ticket rights for which the original buyers have opted out of further payments and that have thus once again become available, and (d) third parties (or “subsequent” buyers) interested in purchasing ticket rights; and (iii) an interface manager implemented on said server and in communication with said databases, wherein said interface manager processes: (a) original purchase commitments from remote original buyers, (b) sale of unsold, resold and opted out ticket rights to third party subsequent buyers, (c) receipt of payments from original and subsequent buyers, and (d) payments between original and subsequent buyers.

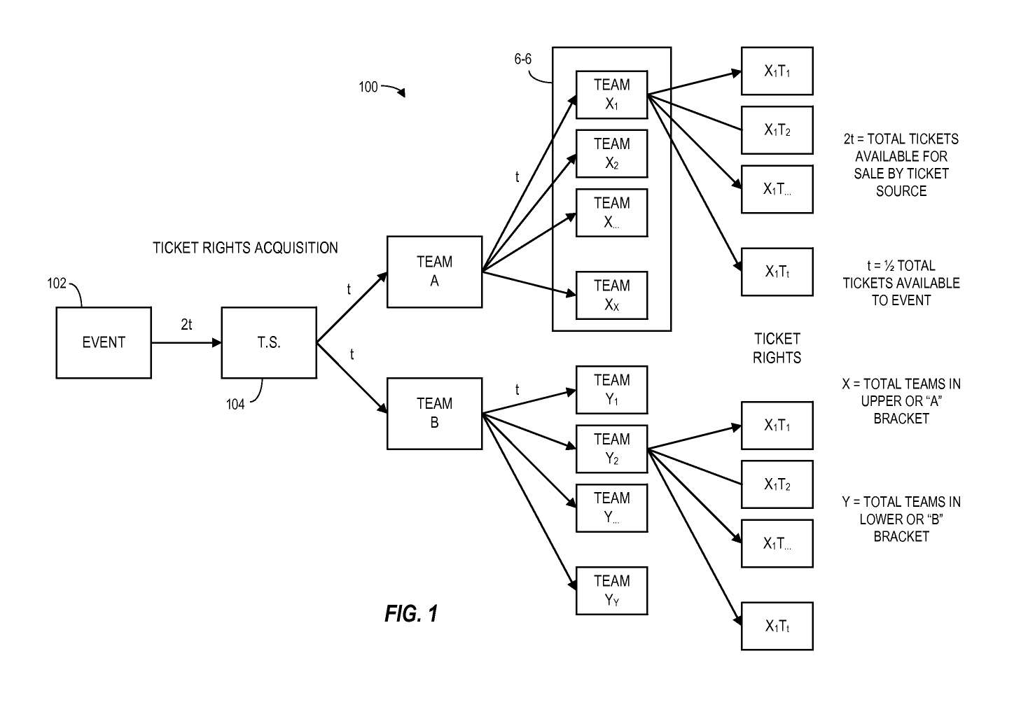

Referring to FIG. 1, the entities involved in ticket rights acquisition in an embodiment of a method and system disclosed herein are depicted in schematic format. In a system 100, tickets are secured from a provider 102, and information concerning such tickets is stored in a primary ticket source (“T.S.”) database 104. The total number of tickets secured and thus available for sale or “2t” is an arbitrary amount that can vary depending upon availability, cost and a myriad of other factors. Inasmuch as only two (2) teams “A” and “B” are expected to participate in most sporting event “finals,” tickets will be sold based upon that fact, i.e., one half of the total tickets available or “t” tickets will be made available to the fans of each team. Thus, the quantity of ticket rights that will be sold to fans of each team will be “t” tickets. The number of brackets (whether denominated as leagues, divisions, conferences or something else) as well as the number of teams in each bracket (x, y or some other number) is irrelevant for implementation of the present invention. All that is important is the number of participants in the final event. Typically there will be merely two participants, as shown, but that is not always the case, e.g., a Nascar event. In practicing the invention it is important to bear in mind that the total number of ticket rights sold cannot exceed the number of tickets that ultimately have to be delivered—regardless of the scenario.

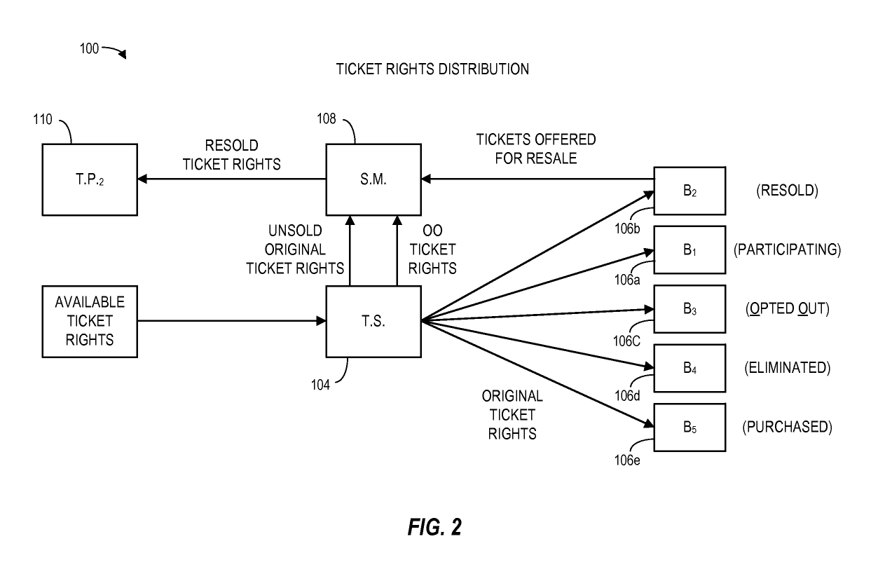

Referring to FIG. 2, the entities involved in ticket rights distribution in an embodiment of a method and system disclosed herein are depicted in schematic format. In the system 100, information pertaining to a plurality of original buyers 106 who purchase original ticket rights is also stored in the primary ticket source database 104. In the embodiment shown, there are five (5) original buyers B1, B2, B3, B4 and B5 labeled 106a, 106b, 106c, 106d and 106e, respectively. A secondary market (“S.M.”) database 108 is provided, on which is stored information concerning unsold original ticket rights, original ticket rights offered for resale, original ticket rights in connection with which original buyers have opted out of making further payments and are thus available for sale (“O.O. ticket rights”), and information pertaining to a plurality of third party subsequent buyers 110 (only one third party subsequent buyer is shown in FIG. 2).

The five original buyers 106 shown in FIG. 2 depict the five (5) different types of buyers. Buyer B1 is the typical buyer who makes a commitment to purchase an original ticket right when initially offered. Buyer B1 will elect to ultimately pursue one of the four other paths (i.e., and thereby become one of the four other types of buyers). In later Figures this Buyer B1 is shown “in the process” of completing the purchase. Buyer B2 represents the type of buyer who elects, after making a certain number of initial payments, to sell the ticket right to a third party—shown in FIG. 2 as T.P.2 (labeled 110). T.P.2 will purchase the ticket right from Buyer B2 via the system 100 and the listing on database 108. This methodology enables the careful tracking of ticket right sales. Buyer B3 represents the type of buyer who elects, after making a certain number of initial payments, to “Opt Out” of the commitment to make subsequent payments without selling the ticket right to a third party. In such circumstances, the Opted Out ticket right (O.O. ticket right) reverts into the primary ticket source database and is, automatically and in turn, transferred to the secondary market database. Buyer B4 represents the type of buyer who makes all required payments right up to the time when the buyer's team is eliminated. Buyer B5 represents the expected majority of buyers, i.e., those who make all requisite payments and thus receive the ticket from the ticket source.

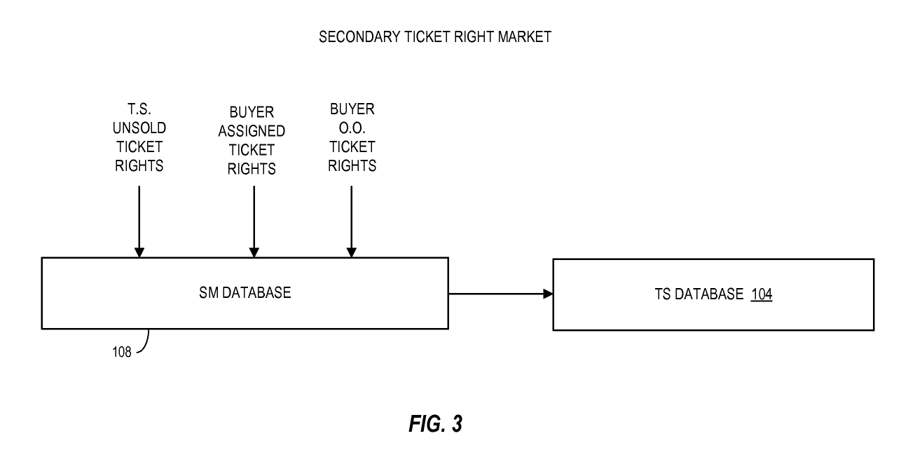

Referring to FIG. 3, the secondary ticket rights market in accordance with an embodiment of this invention is depicted.

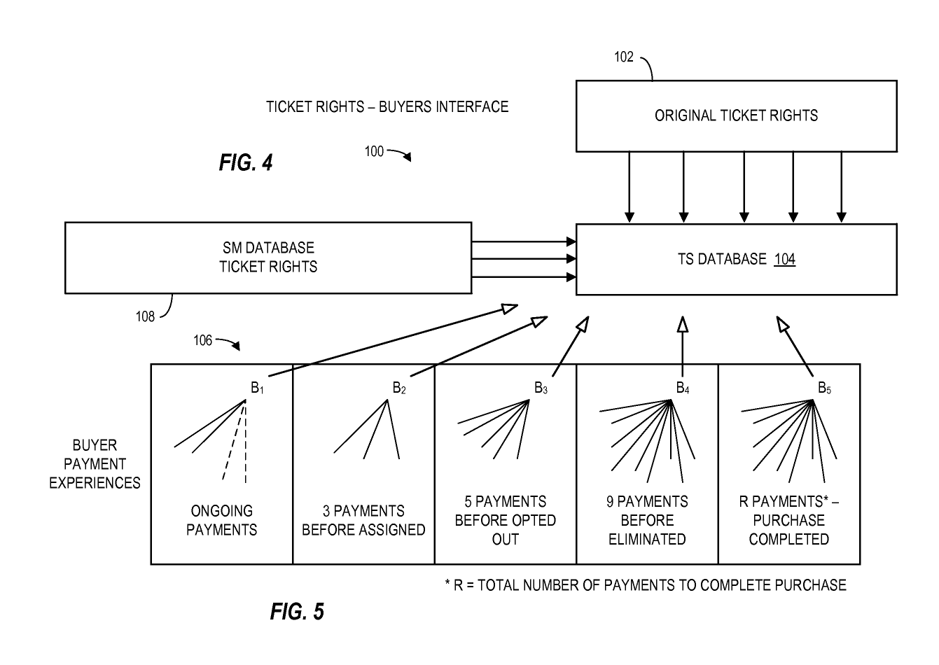

Referring to FIG. 4, the interface between ticket rights and buyers via the primary ticket source database is depicted.

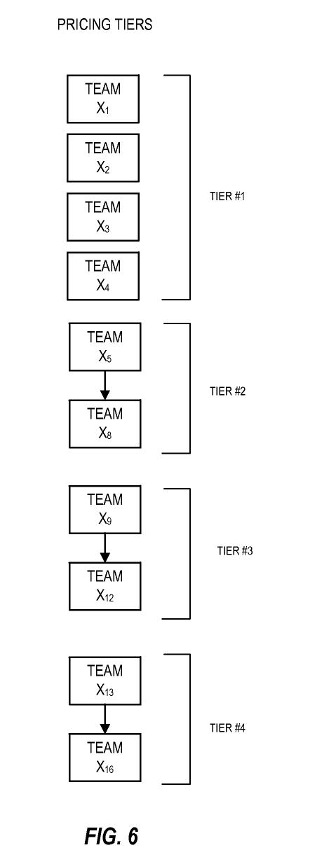

Referring to FIG. 5, the different experiences of the five different buyers is depicted. Buyer B1 reflects the type of buyer making ongoing payments. Buyer B2 reflects the type of buyer who makes three (3) payments then elects to sell the ticket right to a third party. Buyer B3 reflects the type of buyer who makes five (5) payments and then opts out of making further payments (and thereby gives up the right to acquire a ticket). Buyer B4 reflects the type of buyer who faithfully makes all required payments, but whose team is eliminated after nine payments and whose right to secure a ticket is thus lost. Buyer B5 reflects the majority of buyers, i.e., those who make all the requisite payments and receive a ticket.

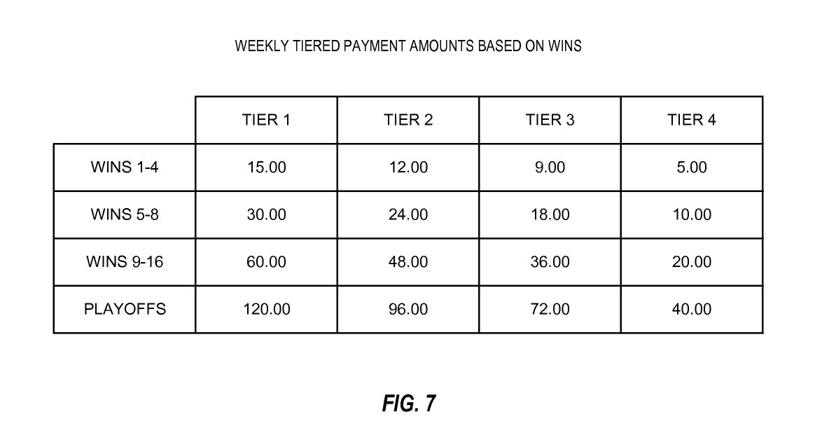

FIG. 6 is a blow up of the portion of FIG. 1 labeled 6-6, showing an exemplary “tier” arrangement in accordance with an embodiment of the invention.

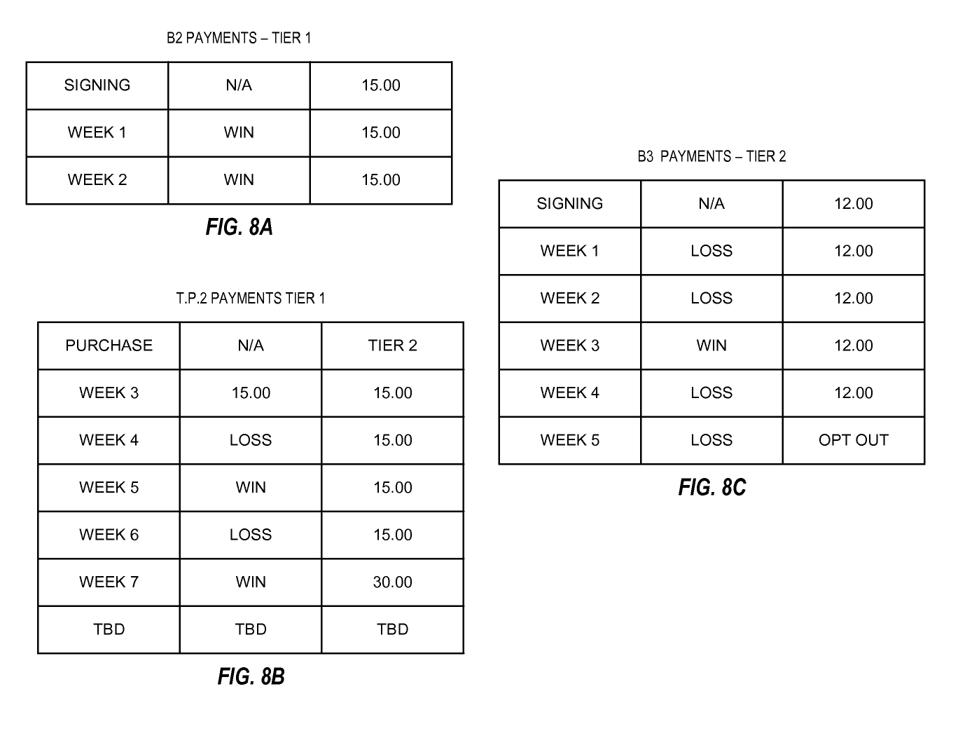

FIG. 7 depicts an exemplary “tier” pricing arrangement, and the manner in which weekly payments increase based upon the number of wins of a team.

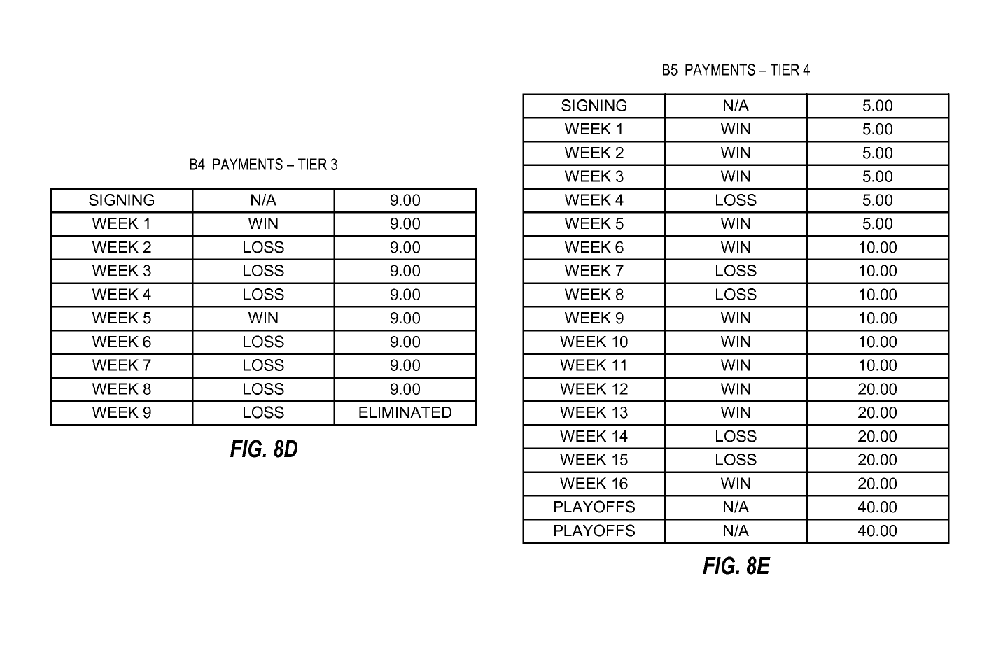

FIGS. 8A through 8E depict the payments that will be made by the five buyers—assuming that the teams they have selected are in the noted tiers, i.e., Buyer B2's team is a Tier 1 team (and thus so also is Third Party 2's team, since Third Party 2 has acquired the ticket right of Buyer B2). Buyer B3's team is a Tier 2 team, Buyer B4's team is a Tier 3 team, and Buyer B5's team is a Tier 4 team.

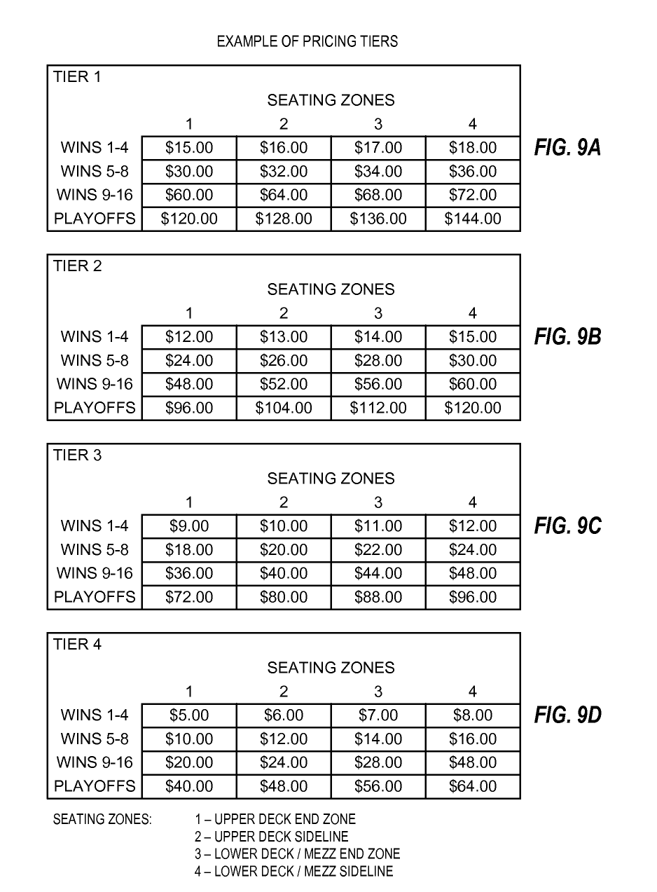

FIG. 9 and FIGS. 9A though 9E show an exemplary “seating zone” arrangement in accordance with an embodiment of the invention.

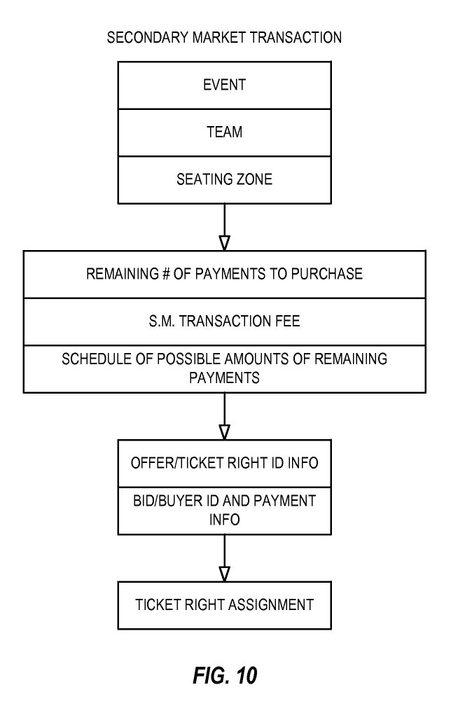

FIG. 10 depicts a flow chart of a secondary market transaction. An individual (whether an original buyer wishing to sell a ticket right they possess, or a third party interested in becoming a subsequent buyer) can access the secondary market database and, upon inputting the event, team and seating zone in connection with which they are interested in offering to sell/purchasing a ticket right, can determine: (i) the remaining number of payments that would be required to purchase such a ticket right, (ii) the transaction fee that would have to be paid to the secondary marketing database as part of the transaction, and (iii) the schedule of possible remaining payments that would have to be paid for the ticket right (i.e., since the outcome of future competitions would be unknown, it would be impossible to provide absolute certainty in this regard). The seller can enter their ticket right information and the price at which they would be prepared to sell the ticket right and authorize the sale without further advance notification. Similarly, the buyer can enter their identifying and payment information and authorize the purchase without further advance notification. When a match between seller and buyer were found, the transaction would be automatically affected.

To further illustrate, the system of the current invention can include conventional components such as a processor, memory (e.g. RAM), a bus which couples the processor and memory, a mass storage device (e.g. a magnetic hard disk or an optical storage disk) coupled to the processor and memory through an I/O controller and a network interface, such as a conventional modem. It will be appreciated from the description below that the present invention may be implemented in software which is stored as executable instructions on a computer readable medium on the client and server systems, such as mass storage devices, or in memories.

In an exemplary embodiment, a browser, residing on the computer of buyer 106, displays a home page retrieved from the World Wide Web on a viewing device, e.g., a screen. A user can view this page by entering, or selecting a link to, a Universal Resource Locator (URL), such as “www.ticketscore.com”, in a browser program, such as MICROSOFT EXPLORER or NETSCAPE NAVIGATOR, executing on the buyer's computer. Note that the subject online system 100 may reside in a server or in a combination of servers.

Focusing now on the network, the presently preferred network is the Internet. The structure of the Internet is well known to those of ordinary skill in the art and includes a network backbone with networks branching from the backbone. These branches, in turn, have networks branching from them, and so on. For a more detailed description of the structure and operation of the Internet, please refer to “The Internet Complete Reference,” by Harley Hahn and Rick Stout, published by McGraw-Hill, 1994. However, one may practice the present invention on a wide variety of communication networks. For example, the network can include interactive television networks, telephone networks, wireless data transmission systems, two-way cable systems, customized computer networks, interactive kiosk networks and automatic teller machine networks.

In addition, the network can include online service providers, such as Microsoft Network, AMERICA ONLINE, PRODIGY and COMPUSERVE. In a preferred embodiment, the online service provider is a computer system which provides Internet access to a buyer 106. Of course, the online service providers are optional, and in some cases, the buyers 106 may have direct access to the Internet.

Focusing now on the buyer 106, the buyer system may be a general purpose computer. In a preferred embodiment, the buyer 106 is equipped with a conventional personal computer equipped with an operating system supporting Internet communication protocols, such as Microsoft Windows, a browser, such as MICROSOFT EXPLORER or NETSCAPE NAVIGATOR, to access the present system and a modem, wireless connection (such as infrared link or satellite dish) or other mechanism for access to the network. In other embodiments, the buyer 106 could, for example, be a computer workstation, a local area network of computers, an interactive television, an interactive kiosk, a personal digital assistant, an interactive wireless communications device or the like which can interact with the network. While the operating systems may differ in such systems, they will continue to provide the appropriate communications protocols needed to establish communication links with the network.

The present system may also include a financial transaction settlement sub-system. The financial transaction settlement sub-system processes various modes of payment for ticket rights, e.g., including processing credit card authorization requests, debit card purchase requests, electronic money (“e-money”) requests, or other such financial transaction request. For example, the financial transaction settlement sub-system may represent commercially available credit card processing institutions.

It should be understood that the systems and methods disclosed herein are not limited to a particular type of contingent event or sport. By way of example, and without limitation, the systems and methods could be used to sell ticket rights to NATIONAL FOOTBALL LEAGUE games, NATIONAL BASKETBALL LEAGUE games, NATIONAL HOCKEY LEAGUE games, MAJOR LEAGUE SOCCER games, MAJOR LEAGUE BASEBALL games, soccer games from leagues throughout the world, games for soccer cups and tournaments, such as the World Cup, FA Cup, European Cup, MLS Cup, and the like, college sports, such as the Men's and Women's NCAA basketball playoffs, tennis and golf tournaments, and other events.

In situations such as the NBA, NHL and MLB playoffs, an additional complication is introduced in that multiple games appear in each round. The first round of playoffs may be a best-of-five series, and the other rounds may be best-of-seven series. Thus, a buyer may be afforded the opportunity to purchase a ticket right, for example, to a game involving the Los Angeles Lakers in the first game of the NBA finals.

It should be understood that the sale of ticket rights is not necessarily limited to playoff games. In fact, some of the benefits of the systems and methods disclosed herein can be obtained with any game where the desirability to attend varies over time. For example, a late-season baseball game between the Red Sox and Yankees would be much more attractive if both teams were in playoff contention than if one or the other was not in contention. Ticket rights could be sold that would enable the buyer to obtain a ticket if a particular combination of events occurred that would make attending the game more attractive to the buyer. For example, the buyer could indicate that s/he wishes to have a ticket right for a Red Sox-Yankees game on a given date if both teams are in contention for the American League East division title.

A wide variety of possible contingent event-based sports events can be enabled by systems and methods disclosed herein. The following examples are intended to illustrate some examples of sports events in connection with which the systems and methods can be used, but are by no means exhaustive. Other embodiments evident to those of ordinary skill in the art are intended to be encompassed by the present disclosure. The examples disclose the intended “roll out” of the systems and methods in connection with a website located at the URL www.Ticketscore.com.

### National Football League

Initial Offering: Super Bowl (single game)
Planned Future offerings:
1. NFC/AFC Championships (single game)
2. Divisional Playoffs (single game)

### Pricing/Buy in System:

1. Four (4) pricing tiers based on starting futures odds
2. Each tier has four (4) pricing levels based on Ticketscore.com designated seating zones
3. All sixteen (16) tier/seating combination starting prices double after a team reaches 5 and 9 wins. Playoff prices are set at 2× the tier's 9 win rate regardless of whether a team ever wins 9 games.
4. Regular season and playoff bye weeks are charged at the appropriate pricing level based on team's win total.
5. Customer can opt out at any given time during the season if they are unhappy with their team's progress and not be billed any additional cost.
6. All recurring billing will take place on Friday
7. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
8. Buy In Deadlines—Start of regular season.
9. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### Major League Baseball

Initial Offering: World Series (series)
Planned Future offerings:
1. AL/NL Championships (series)
2. Divisional Playoffs (series)

### Pricing/Buy in System:

1. Four (4) pricing tiers based on starting futures odds (much lower than NFL due to length of season and cheaper ticket costs)
2. Each tier has four (4) pricing levels based on Ticketscore.com designated seating zones
3. Since MLB World Series is 7 games, customers can buy into futures for guaranteed home games (2 in a best of seven series).
4. All sixteen (16) tier/seating combination starting prices increase a set dollar amount after a team reaches 51 and 71 wins. Playoff prices are set at 2× the tier's 71 win rate regardless of whether a team ever wins 71 games.
5. All-Star weekend counts as a normal week despite the fact that fewer games are played and each team is charged at the appropriate pricing level based on the team's win total at that time.
6. Customer can back out at any given time during the season if they are unhappy with their team's progress and not be billed any additional cost.
7. All recurring billing will take place on Friday
8. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
9. Buy In Deadlines—Start of regular season.
10. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### National Basketball Association

Initial Offering: NBA Finals (series)
Planned Future offerings:
1. Conference finals (series)
2. Divisional Playoffs (series)

### Pricing/Buy in System:

1. Four (4) pricing tiers based on starting futures odds
2. Each tier has four (4) pricing levels based on Ticketscore.com designated seating zones
3. Since NBA Finals is 7 games, customers can buy in to futures for guaranteed home games (2 in a best of seven series).
4. All sixteen (16) tier/seating combination starting prices increase a set dollar amount after a team reaches 26 and 51 wins. Playoff prices are set at 2× the tier's 51 win rate regardless of whether a team ever wins 51 games.
5. All-Star week counts as a normal week despite the fact that fewer games are played and each team is charged at the appropriate pricing level based on the team's win total at that time.
6. Customer can back out at any given time during the season if they are unhappy with their team's progress and not be billed any additional cost.
7. All recurring billing will take place on Friday
8. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
9. Buy In Deadlines—Start of regular season.
10. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### National Hockey League

Initial Offering: NHL Finals (series)
Planned Future offerings:
1. Conference Championship (series)
2. Divisional Playoffs (series)

### Pricing/Buy in System:

1. Four (4) pricing tiers based on starting futures odds
2. Each tier has four (4) pricing levels based on Ticketscore.com designated seating zones
3. Since NHL Finals are 7 games, customers can buy into futures for guaranteed home games (2 in a best of seven series).
4. All sixteen (16) tier/seating combination starting prices increase a set dollar amount after a team reaches 26 and 51 wins. Playoff prices are set at 2× the tier's 51 win rate regardless of whether a team ever wins 51 games.
5. All-Star week counts as a normal week despite the fact that fewer games are played and each team is charged at the appropriate pricing level based on team's win total at that time.
6. Customer can back out at any given time during the season if they are unhappy with their team's progress and not be billed any additional cost.
7. All recurring billing will take place on Friday
8. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
9. Buy In Deadlines—Start of regular season.
10. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### NCAA Football

### Initial Offerings:

### 1. Tostitos BCS National Championship Game

### 2. Tostitos Fiesta Bowl

### 3. Rose Bowl 4. Sugar Bowl

### 5. Orange Bowl

Planned Future offerings:
1. Other high profile bowl games with significant ticket demand

### Pricing/Buy in System:

1. Four (4) pricing tiers based on starting futures odds (approx 50 teams offered within 4 tiers)
2. Each tier has four (4) pricing levels based on Ticketscore.com designated seating zones
3. All sixteen (16) tier/seating combination starting prices increase a set dollar amount after a team reaches 5 and 9 wins. There is no playoff system in NCAAF.
4. Regular season bye week is charged at the appropriate pricing level based on teams win total.
5. Customer can back out at any given time during the season if they are unhappy with their teams progress and not be billed any additional cost.
6. All recurring billing will take place on Friday
7. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
8. Buy In Deadlines—Start of regular season.
9. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### NCAA Basketball

### Initial Offerings:

### 1. NCAA Championship Game

### 2. NCAA Final Four

Planned Future offerings: None

### Pricing/Buy in System:

1. Four (4) pricing tiers based on starting futures odds (approx 100 teams offered within 4 tiers)
2. Each tier has four (4) pricing levels based on Ticketscore.com designated seating zones
3. Since NCAAB games are single elimination, there are no series and only one game is offered for final four and championship game
4. All sixteen (16) tier starting prices increase a set dollar amount after a team reaches 11 and 21 wins and in each round of the NCAA tournament.
5. There are no bye weeks as teams play multiple games per week
6. Customer can back out at any given time during the season if they are unhappy with their team's progress and not be billed any additional cost.
7. All recurring billing will take place on Friday
8. Second Chance Pool—All customers who opt out of their future will be given the option to stay in (continue to be billed for remainder of season) at a discounted weekly fee to participate in Ticketscore's “Second Chance” pool. If a customer stays in the “Second Chance” pool for the remainder of their season, they will be eligible for a free Ticketscore future.
9. Buy In Deadlines—Start of regular season.
10. Secondary Market—Ticketscore.com will operate an affiliate company that is the sole authorized reseller of Ticketscore products. Customers will be able to list existing products for sale on the secondary market so long as they continue to buy into the products through Ticketscore. Once a product is sold, ownership will be transferred to the buyer through Ticketscore.com and the new owner will continue paying the weekly buy-in price. Any premium paid by a buyer is paid directly to the seller. Ticketscore will charge a service fee to transfer ownership of futures. Ticketscore.com will also sell futures on the secondary market that were opted out of by customers on Ticketscore.com. Buyers of these futures will also pay a service fee.

### Other Potential Future Offerings:

### 1. Soccer

### 2. Tennis

### 3. NASCAR

4. “NCAAF Bowl Package”—where you select a team and you receive a ticket if they make ANY of the bowls that are bundled in the package. At the moment this is only envisioned for college football as there aren't any other sports with many different post season games that are not linked to each other—but this could be used if such opportunities are created in connection with other college sports.
5. Specific Matchups—where you select a specific Super Bowl matchup, e.g., Jets vs Giants, and you receive a ticket if this is the matchup in the Super Bowl. This would be a much cheaper option for a customer, but probably not as popular as the odds would be low of scoring a ticket.

While the invention has been disclosed in connection with the preferred embodiments shown and described in detail, various modifications and improvements thereon will become readily apparent to those skilled in the art. By way of example, the application discloses the use of the systems and methods in connection with the sale of tickets. It should be understood that the invention can be practiced via the offering of other commodities, such as airfare, hotel and rental car accommodations, either separately and/or in conjunction with tickets. Accordingly, the spirit and scope of the present invention is to be limited only by the following claims.

We claim:

1. A system for allowing a user to purchase a ticket to an event for which a plurality of potential participants could qualify but in connection with which none of the potential participants have yet qualified, comprising a host server operative with a program including a primary ticket source database connected in communication with said host server, said primary database including information pertaining to:
(a) multiple tickets available for such event;
(b) multiple rights available to purchase such tickets for such event;
(c) the identities of potential participants in such event; and
(d) at least one buyer who is willing to commit to purchase at least one such ticket right in advance and to make periodic payments towards the purchase of such ticket right based upon the conditions that such buyer will only receive such ticket if the potential participant of interest to such buyer qualifies for such event and if such buyer makes all required periodic payments in connection with such ticket right;
wherein such buyer makes such periodic payments until such time as:
(a) such buyer elects to opt out of the system and to relinquish such ticket right;
(b) the potential participant of interest to such buyer is eliminated and such ticket right of such buyer lapses; or
(c) such buyer makes all required periodic payments in connection with such ticket right and such buyer receives such ticket.

2. The system of claim 1, wherein such primary database further includes information pertaining to tiered pricing set for such ticket rights, and wherein the amount at which such periodic payments are initially set increases as a first function of increases in the perceived likelihood of the potential participant qualifying to participate in such event.

3. The system of claim 1, wherein the amount of such periodic payments increases over time as a second function of increases in the actual likelihood of the potential participant qualifying to participate in such event.

4. The system of claim 1, wherein such primary database further includes information pertaining to tiered pricing set for such ticket rights, and wherein the amount at which such periodic payments are initially set increases as a first function of increases in the perceived likelihood of the potential participant qualifying to participate in such event, and wherein the amount of such periodic payments increases over time as a second function of increases in the actual likelihood of the potential participant qualifying to participate in such event.

5. The system of claim 4, wherein such event is a championship sporting event, wherein prior to such championship sporting event there are one or more qualifying sporting events leading up to such championship sporting event, and wherein such second function is a factor of the wins of the potential participant in such prior qualifying sporting events.

6. The system of claim 1, wherein such primary database further includes information pertaining to tiered pricing set for such ticket rights based upon the desirability of the seating at such event and wherein the amount of such periodic payments increases as a third function of the desirability of the seating at such event selected by such buyer.

7. The system of claim 1, wherein the amount at which such periodic payments are initially set increases as a first function of increases in the interest or demand for such ticket rights based upon the potential participant.

8. The system of claim 1, wherein such primary database further includes information pertaining to: first tiered pricing set for such ticket rights as a first function of the desirability of the seating at such event; and second tiered pricing set for such ticket rights as a second function of: (i) the interest or demand for such ticket rights based upon the potential participant; and (ii) the perceived likelihood of potential participants qualifying for such event; and wherein the amount of such periodic payments increases as a third function of the actual likelihood of the potential participant qualifying for such event.

9. The system of claim 1, wherein such buyer makes such periodic payments until such time as:
(a) such buyer elects to opt out of the system and to relinquish such ticket right;
(b) such buyer elects to resell such ticket right to a third party;
(c) the potential participant of interest to such buyer is eliminated and such ticket right of such buyer lapses; or
(d) such buyer makes all required periodic payments in connection with such ticket right and such buyer receives such ticket.

10. A system for allowing a user to purchase a ticket to an event for which a plurality of potential participants could qualify but in connection with which none of the potential participants have yet qualified, comprising a host server operative with a program including:
(i) a primary ticket source database connected in communication with said host server, said primary database including information pertaining to: (a) original ticket rights available for such event; (b) the identities of potential participants in such event; (c) original buyers who have committed to purchase the original ticket rights; (d) pricing and required periodic payments from the original buyers for the original ticket rights; and (e) subsequent buyers interested in purchasing ticket rights that might become available; and
(ii) an interface manager implemented on said host server and in communication with said databases, wherein said interface manager processes: (a) original purchase commitments from such original buyers, (b) sale of unsold and opted out ticket rights to such subsequent buyers, (c) receipt of periodic payments from such original and subsequent buyers.

11. The system of claim 10, wherein such primary database further includes information pertaining to tiered pricing set for such ticket rights, and wherein the amount at which such periodic payments are initially set increases as a first function of increases in the perceived likelihood of the potential participant qualifying to participate in such event.

12. The system of claim 10, wherein the amount of such periodic payments increases over time as a second function of increases in the actual likelihood of the potential participant qualifying to participate in such event.

13. The system of claim 10, wherein such primary database further includes information pertaining to tiered pricing set for such ticket rights, and wherein the amount at which such periodic payments are initially set increases as a first function of increases in the perceived likelihood of the potential participant qualifying to participate in such event, and wherein the amount of such periodic payments increases over time as a second function of increases in the actual likelihood of the potential participant qualifying to participate in such event.

14. The system of claim 13, wherein such event is a championship sporting event, wherein prior to such championship sporting event there are one or more qualifying sporting events leading up to such championship sporting event, and wherein such second function is a factor of the wins of the potential participant in such prior qualifying sporting events.

15. The system of claim 10, wherein such primary database further includes information pertaining to tiered pricing set for such ticket rights based upon the desirability of the seating at such event and wherein the amount of such periodic payments increases as a third function of the desirability of the seating at such event selected by such buyer.

16. The system of claim 10, wherein such primary database further includes information pertaining to: first tiered pricing set for such ticket rights as a first function of the desirability of the seating at such event; and second tiered pricing set for such ticket rights as a second function of the perceived likelihood of potential participants qualifying for such event; and wherein the amount of such periodic payments increases as a third function of the actual likelihood of the potential participant qualifying for such event.

17. A system for allowing a user to purchase a ticket to an event for which a plurality of potential participants could qualify but in connection with which none of the potential participants have yet qualified, comprising a host server operative with a program including:
(i) a primary ticket source database connected in communication with said host server, said primary database including information pertaining to: (a) original ticket rights available for such event; (b) the identities of potential participants in such event; (c) original buyers who have committed to purchase the original ticket rights; and (d) pricing and required periodic payments from the original buyers for the original ticket rights;
(ii) a secondary market database connected in communication with said host server and said primary ticket source database, said secondary market database including information pertaining to: (a) unsold original ticket rights available for such event, (b) ticket rights offered for resale by original buyers of original ticket rights, (c) ticket rights for which the original buyers have opted out of making further periodic payments and that have thus once again become available, and (d) subsequent buyers interested in purchasing such ticket rights; and
(iii) an interface manager implemented on said host server and in communication with said databases, wherein said interface manager processes: (a) original purchase commitments from such original buyers, (b) sale of unsold, resold and opted out ticket rights to such subsequent buyers, (c) receipt of periodic payments from such original and subsequent buyers, and (d) purchase payments exchanged between such original and subsequent buyers.

18. The system of claim 17, wherein such primary database further includes information pertaining to tiered pricing set for such ticket rights, and wherein the amount at which such periodic payments are initially set increases as a first function of the potential participant for which the buyer commits to purchase a ticket right, wherein the amount of such periodic payments increases over time as a second function of increases in the actual likelihood of the potential participant qualifying to participate in such event.

19. The system of claim 18, wherein such event is a championship sporting event, wherein prior to such championship sporting event there are one or more qualifying sporting events leading up to such championship sporting event, and wherein such second function is a factor of the wins of the potential participant in such prior qualifying sporting events.

20. The system of claim 18, wherein such primary database further includes information pertaining to tiered pricing set for such ticket rights based upon the desirability of the seating at such event and wherein the amount of such periodic payments increases as a third function of the desirability of the seating at such event selected by such buyer.
